(19) United States
(12) Patent Application Publication
(10) Pub. No.: US 2015/0034750 A1
(43) Pub. Date: Feb. 5, 2015

(54) EDGE WEAR COMPONENTS FOR ROLLER PRESSES

(71) Applicant: FLSmidth A/S, Valby (DK)

(72) Inventor: Edward James Pownell, Midvale, UT (US)

(21) Appl. No.: 14/350,116

(22) PCT Filed: Oct. 5, 2012
(86) PCT No.: PCT/US12/59108

§ 371 Date: Apr. 7, 2014

Related U.S. Application Data
(60) Provisional application No. 61/545,046, filed on Oct. 7, 2011.

(51) Int. Cl. B02C 4/30

(52) U.S. Cl. CPC B02C 4/305
USPC 241/294

(57) ABSTRACT

A roller press having an improved edge wear assembly is disclosed. The roller press comprises a roller [200] having an axis [203]. The roller [200] comprises an outer surface [205] containing one or more wear inserts [280] and an annular abutment surface [207] proximate an end of the outer surface [205]. The annular abutment surface [207] extends generally transversely with respect to the outer surface [205] of the roller [200]. A plurality of wear components [211] extend from the abutment surface [207] in a direction generally parallel to the axis [203] of the roller [200], wherein at least two of the wear components [211] are circumferentially interlocked with one another so as to resist axial and/or radial pull-off forces as material flows between other wear inserts [280] located on the roller [200]. Fasteners [230] are received by receiving portions [215] in and secure the wear components [211] to the abutment surface [207] of the roller [200].

### BACKGROUND OF THE INVENTION

This invention relates to crushing, grinding, and comminution equipment, and more particularly to high pressure grinding roller (HPGR) press systems used, for instance, in the mining, cement, and minerals industries.

Currently, when roller edges erode, workers must fill gaps and worn-away roller material with hard-facing weld material. Subsequent grinding and machining process on the roller may be necessary after welding in order to bring the roller back to original specifications.

Recent attempts have been made to address edge wear. For instance, KHD and Polysius have pursued roller designs which incorporate fastening of removable hard bodies to the roller edges (see U.S. Pat. Nos. 7,497,397 and 7,510,135). However, these designs fail to provide adequate support and stability for the hard bodies under tangential shear in at least a circumferential direction, while still preserving ease of maintenance and/or removal of the hard bodies. Moreover, the designs fail to provide adequate resistance to axial pull-off forces as material flows axially between studs or other wear inserts located on the roller. Moreover, these designs fail to provide adequate resistance to radial pull-out forces.

### OBJECTS OF THE INVENTION

It is, therefore, an object of the invention to provide a mechanically-robust edge wear component system.

It is also an object of the invention to provide adequate support and stability for wear components under tangential shear loads in at least a circumferential direction, while still preserving ease of maintenance and/or removal of the hard bodies.

Furthermore, it is an object of the invention to provide adequate resistance to axial pull-off forces as material flows axially between wear inserts located on the roller.

Moreover, it is an object of the invention to provide adequate resistance to radial pull-off forces as material flows between wear inserts located adjacent edge portions of the roller.

These and other objects of the invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

A roller press having an improved edge wear assembly is disclosed. The roller press comprises a roller having an axis. The roller comprises an outer surface containing one or more wear inserts and an annular abutment surface proximate an end of the outer surface. The annular abutment surface extends generally transversely with respect to the outer surface of the roller. A plurality of wear components extend from the abutment surface in a direction generally parallel to the axis of the roller, wherein at least two of the wear components are circumferentially interlocked with one another so as to resist axial and/or radial pull-off forces as material flows between other wear inserts located on the roller. Fasteners are received by receiving portions in and secure the wear components to the abutment surface of the roller.

### BRIEF DESCRIPTION OF THE DRAWINGS

FIG. 1 is a side view of a roller sleeve assembly according to the prior art, showing edge wear components which fail to provide resistance to axial pull-off forces;

FIG. 2 is a side view of a roller sleeve assembly according to some embodiments, showing interlocking edge wear components which provide resistance to axial pull-off forces;

FIG. 3 is a detailed view of an interlocking edge wear component as shown in FIG. 2;

FIG. 4A is a cross-sectional view of a roller edge according to some embodiments;

FIG. 4B is an isometric view of a chevron- or feathered-style first hard material component;

FIG. 5 is an exploded detailed view of the assembly shown in FIG. 4A;

FIG. 6 is an end view of the roller edge shown in FIG. 4;

FIGS. 7A-7D are detailed views of a wear component according to some embodiments;

FIG. 8 is an end view of an alternative wear component according to some embodiments;

FIG. 9 is a cross-sectional view of a roller edge according to some embodiments;

FIG. 10 is a side view of a roller according to some embodiments;

FIG. 11 is a side view of a roller according to some embodiments;

FIG. 12 is an isometric view of a roller according to some embodiments;

FIG. 13 is a detailed side view of a wear component shown in FIG. 12; and,

FIG. 14 is a side view of a wear component according to embodiments incorporating a radially-oblique angle.

### DETAILED DESCRIPTION OF THE INVENTION

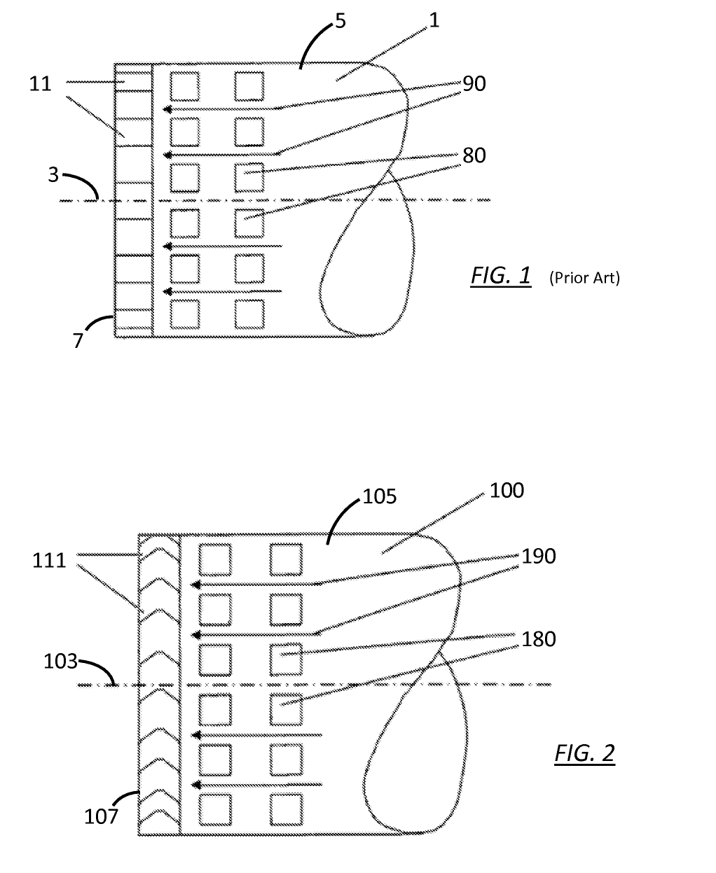

FIG. 1 is a side view of a roller according to the prior art, showing edge wear components which fail to adequately provide resistance to axial pull-off forces. Autogenous layer material builds up on the outer surface 5 of roller 1 between wear inserts 80 and follows a path of least resistance, along flow path 90 in a direction generally parallel to the roller axis 3. Over time, the autogenous layer material washes out portions of the roller 1 and pushes axially against inner side portions of edge wear components 11. Over time, wear components 11 become less and less supported by the roller 1, and eventually move past an abutment surface 7 of the roller. Finally, wear components 11 dislodge from the roller 1, thereby leaving the roller 1 susceptible to damage and expedited wear.

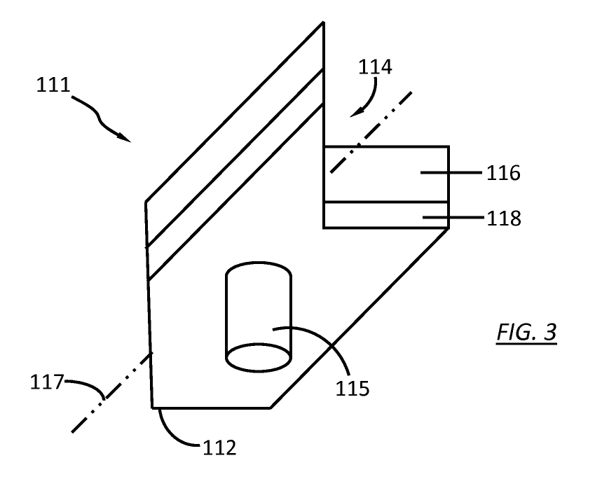

FIGS. 2-3 show an improved roller 100 according to a first embodiment. The roller 100 comprises a plurality of wear inserts 180 provided on an outer surface 105. Flow paths 190 may exist, defining paths of least resistance for autogenous layer material. Interlocking edge wear components 111 are provided at the edge of the roller 100. The wear components 111 may be provided within an annular shelf, one or more pockets, grooves, a series of circumferentially-spaced holes, or bolted to an abutment surface 107 defining an end side portion of the roller 100. In the shown embodiment, wear components 111 are received within a series of circumferentially-spaced holes (not shown) provided on the roller 100 in areas adjacent the edge. One or more mounting bosses 115 provided on each wear component 111 help secure the wear component 111 to the roller 100.

As shown in more detail in FIG. 3, wear components 111 generally comprise at least a first hard material component 116, a male interlocking feature 112, and a female interlocking feature 114. Preferably, the interlocking features 112, 114 are aligned along an axis 117 which runs generally parallel to a tangent line along the edge of the roller 100. The first hard material component 116 of each wear component 111 may comprise a carbide (e.g., tungsten carbide), and a first base material component 118 may comprise a softer material such as vanadium or tool steel.

As autogenous material and/or feed follows flow paths 190 in a direction along roller axis 103, it is held back by wear components 111. Wear components 111 may be recessed, flush, or sit proud with respect to the outer surface 105, in order to form a material dam. Since male and female interlocking features 112, 114 are interconnected or interfitted with adjacent male and female interlocking features 112, 114 of circumferentially-adjacent wear components 111, a greater resistance to axial pull-off is provided, as each wear component 111 is additionally supported by surrounding wear components.

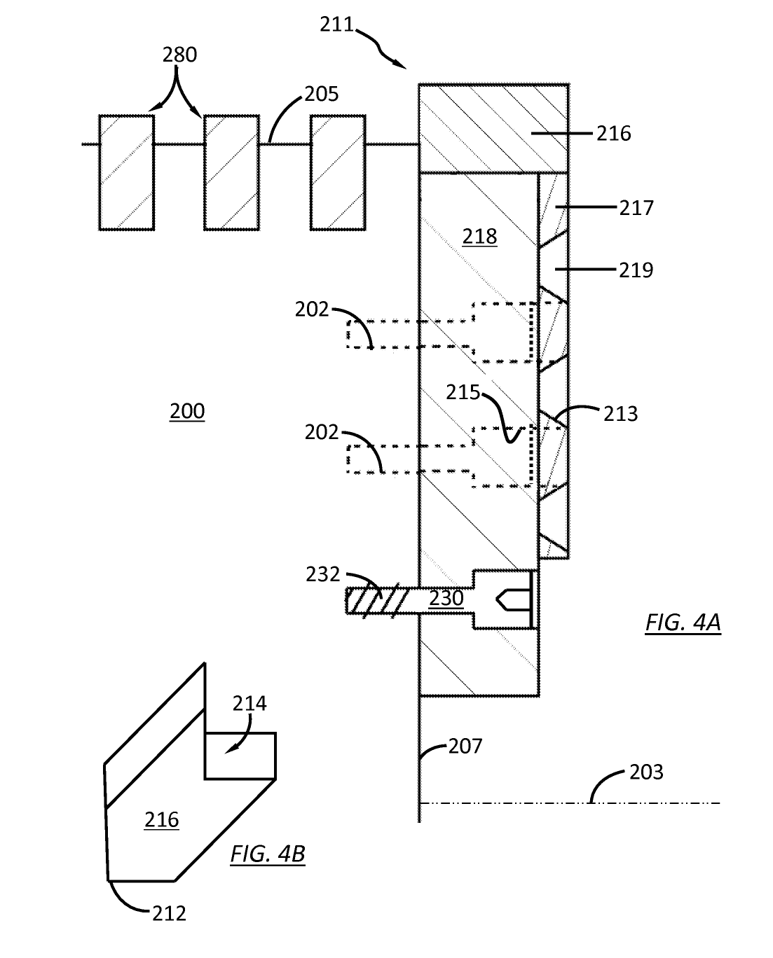

FIG. 4A is a cross-sectional view of a roller edge according to another embodiment. A roller 200 comprises a plurality of wear inserts 280 provided on an outer surface 205. A number of interlocking wear components 211 are provided at the edge of the roller 200. The wear components 211 may be provided within an annular shelf, a series of circumferentially-spaced holes, or bolted to a planar abutment surface 207 defining an end side portion of the roller 200 as shown. As shown in more detail in FIG. 4B, wear components 211 may generally comprise at least a first hard material component 216 having a male interlocking feature 212, and a female interlocking feature 214. Preferably, the interlocking features 212, 214 are aligned perpendicular to the axis 203 of the roller 200. The first hard material component 216 of each wear component 211 may comprise a carbide (e.g., tungsten carbide), and a first base material component 218 (e.g., permanently attached to the first hard material component via soldering, welding, adhering, or other permanent joining technique) may comprise a softer material such as vanadium or tool steel. First base material component 218 may reduce the overall manufacturing cost of the wear component 211, and may facilitate machining of at least one receiving portion 215 configured to receive at least one fastener 230 having an attachment feature 232 (e.g., threads). One or more complimentary attachment features 202 provided to the roller 200 accept said at least one fastener 230 and hold the wear component 211 against abutment surface 207 at the edge of the roller 200.

A second hard material component 217 may also be attached to the first base material component 218 in order to prevent backside washout and wear. A series of channels 213 may be provided within the second hard material component to accommodate a solder or weld bead 219 to join the second hard material component 217 to the first base material component 218.

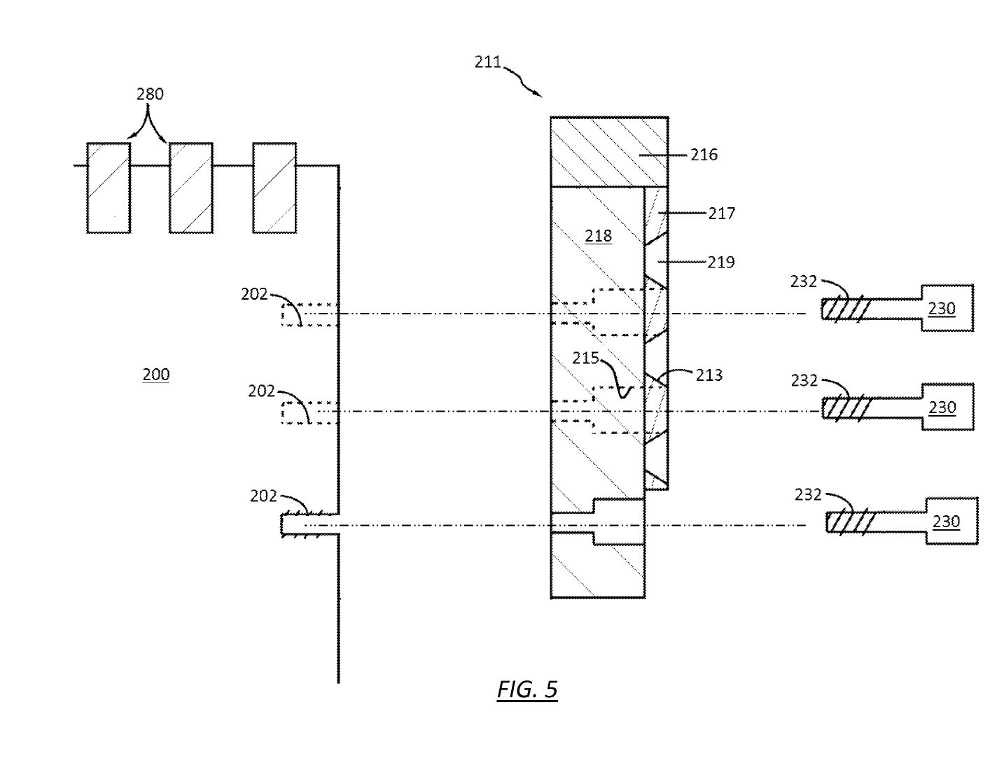

FIG. 5 is an exploded detailed view of the assembly shown in FIG. 4A. A single piece wear component 211 is formed by soldering, welding, gluing, adhering, pressing, or otherwise fusing together, a first base material component 218, a first hard material component 216, and a second hard material component 217. FIG. 6 is an end view of the roller edge shown in FIG. 4, showing the wear component 211 installed onto the abutment surface 207 of the roller 200;

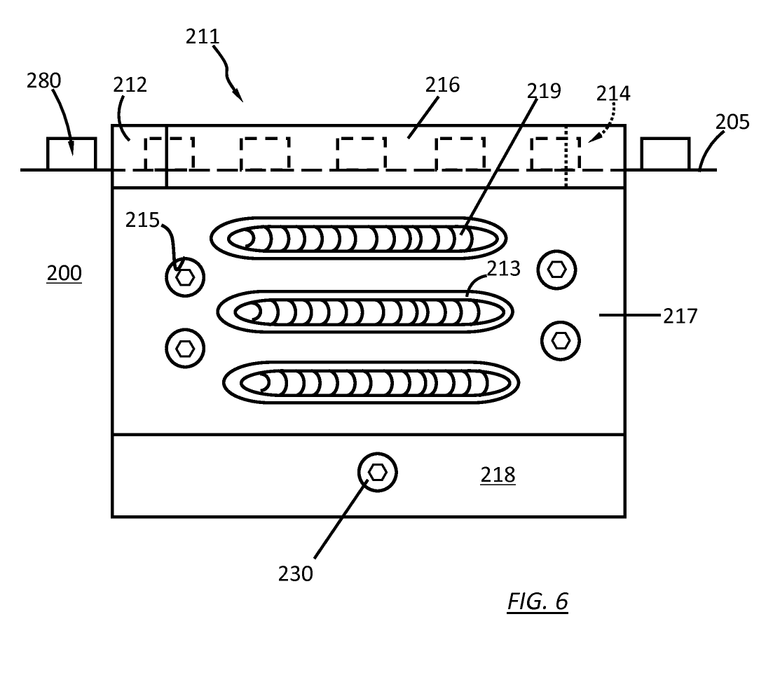

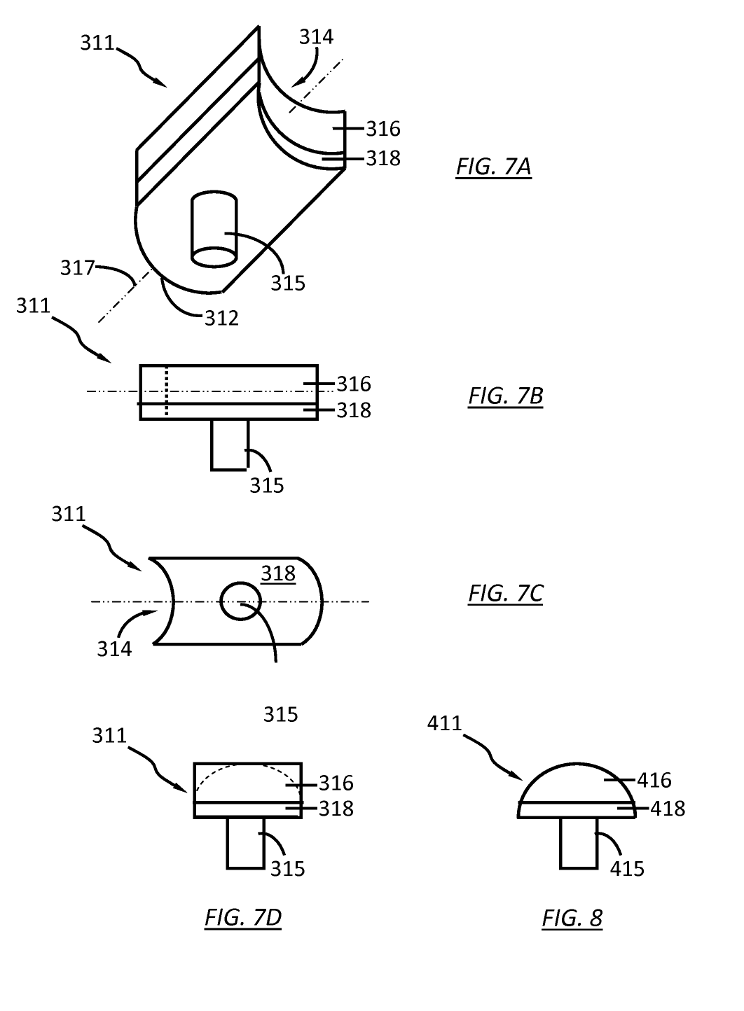

FIGS. 7A-7D are detailed views of a wear component 311 according to some embodiments. The wear component 311 shown may be used alone and applied to receiving portions within an edge surface of a roller (as shown in FIGS. 2 and 3), or may be permanently attached to other components to form a larger wear component (as shown in FIGS. 4A, 5, 6, and 9). The wear component 311 comprises a first hard material component 316, an optional first base material component 318 formed of a softer material, a female interlocking feature 314 and a male interlocking feature 312 preferably aligned along an axis 317, and a mounting boss 315 which extends from the first base material component 318. Male 312 and female 314 interlocking features are complimentary in shape and size and may form a puzzle-like fit when joined. As shown in FIG. 7D in dotted lines, the first hard material component 316 may be rounded or chamfered in at least one profile view to reduce fracture during commissioning and break-in period of the roller. For example, in some instances, such as the embodiment shown in FIG. 8, a wear component 411 may comprise a first hard material component 416 in the form of a semi-spherical button. The wear component 411 may similarly comprise a first base material component 418 and mounting boss 415.

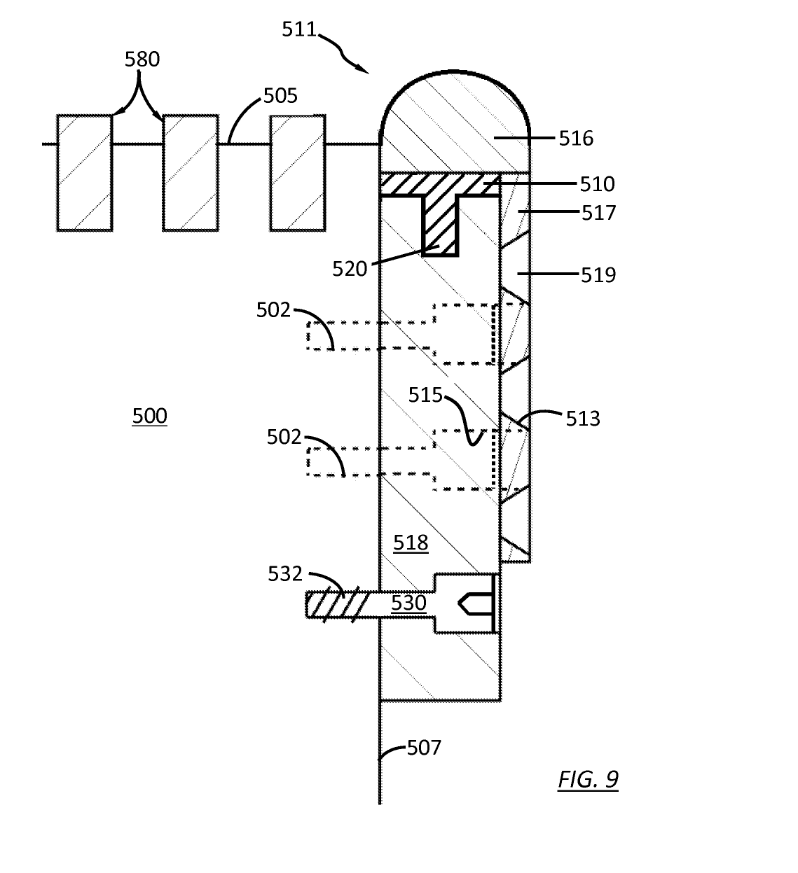

FIG. 9 is a cross-sectional view of a roller edge according to some embodiments. A roller 500 comprises a plurality of wear inserts 580 provided on an outer surface 505. A number of interlocking wear components 511 are provided at the edge of the roller 500. The wear components 511 may be provided within an annular shelf, a series of circumferentially-spaced holes, or bolted to a planar abutment surface 507 defining an end side portion of the roller 500 as shown. Wear components 511 may generally comprise at least a first hard material component 516, which may have male and female interlocking feature (not shown). The first hard material component 516 of each wear component 511 may comprise a carbide (e.g., tungsten carbide), and a first base material component 518 (e.g., permanently attached to the first hard material component via soldering, welding, adhering, or other permanent joining technique) may comprise a softer material such as vanadium or tool steel. An intermediate second base material component 510 may be provided between the first hard material component 516 and the first base material component 518 to facilitate manufacturing assembly and bonding. Second base material component 510 may comprise one or more mounting bosses 520 which are received within first base material component 518. First 518 and second 510 base material components may reduce the overall manufacturing cost of the wear component 511, and may facilitate machining of receiving portions 515 configured to receive fasteners 530 having attachment features 532. One or more complimentary attachment features 502 are provided to the roller 500 and accept said fasteners 530 and hold the wear component 511 against abutment surface 507 at the edge of the roller 500.

A second hard material component 517 may also be attached to the first base material component 518 in order to prevent backside washout and wear. A series of channels 513 may be provided within the second hard material component to accommodate a solder or weld bead 519 to join the second hard material component 517 to the first base material component 518.

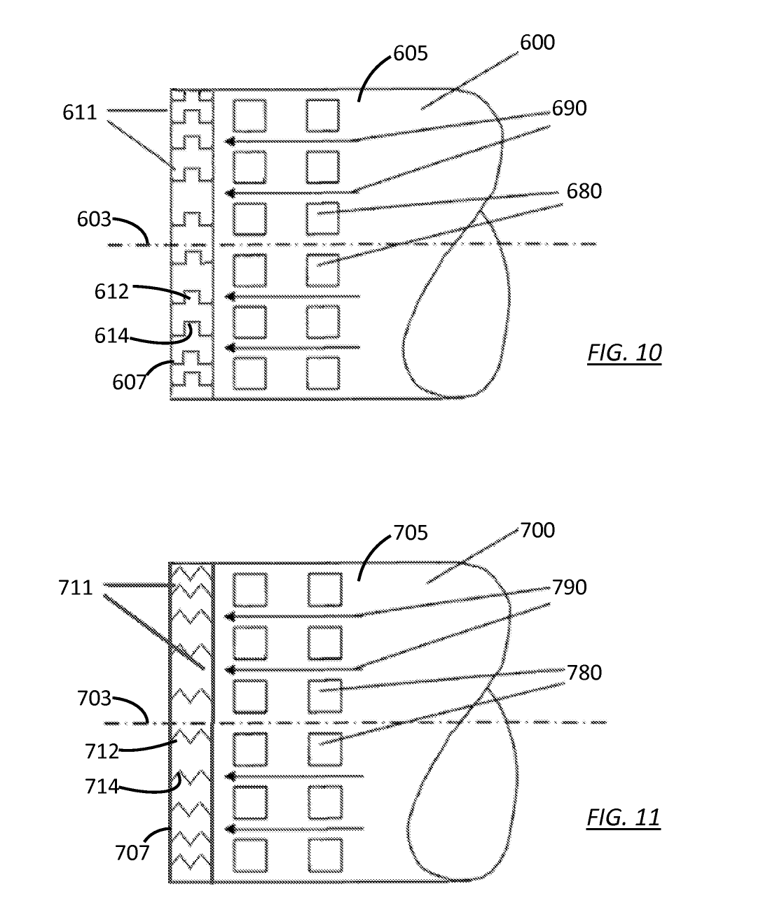

FIG. 10 is a side view of a roller 600 according to some embodiments. The roller 600 comprises a plurality of wear inserts 680 provided on an outer surface 605. Flow paths 690 may exist, defining paths of least resistance for autogenous layer material. Interlocking edge wear components 611 are provided at the edge of the roller 600. The wear components 611 may be provided within an annular shelf, one or more pockets, grooves, a series of circumferentially-spaced holes, or bolted to an abutment surface 607 defining an end side portion of the roller 600. In the shown embodiment, wear components 611 are received within a series of circumferentially-spaced holes (not shown) provided on the roller 600 in areas adjacent the edge. One or more mounting bosses may be provided to each wear component 611 in order to help secure the wear component 611 to the roller 600.

Wear components 611 generally comprise a male interlocking feature 612, and a female interlocking feature 614. The interlocking features 612, 614 are generally aligned and may comprise a polyhedral shape. While not shown, interlocking features 612, 614 may comprise undercuts or dovetail joint portions therebetween.

As autogenous material and/or feed follows flow paths 690 in a direction along roller axis 603, it is held back by wear components 611. Wear components 611 may be recessed, flush, or sit proud with respect to the outer surface 605, in order to form a material dam. Since male and female interlocking features 612, 614 are interconnected or interfitted with adjacent male and female interlocking features 612, 614 of circumferentially-adjacent wear components 611, a greater resistance to axial pull-off is provided, as each wear component 611 is additionally supported by surrounding wear components 611.

FIG. 11 is a side view of a roller 700 according to some embodiments. The roller 700 comprises a plurality of wear inserts 780 provided on an outer surface 705. Flow paths 790 may exist, defining paths of least resistance for autogenous layer material. Interlocking edge wear components 711 are provided at the edge of the roller 700. The wear components 711 may be provided within an annular shelf, one or more pockets, grooves, a series of circumferentially-spaced holes, or bolted to an abutment surface 707 defining an end side portion of the roller 700. In the shown embodiment, wear components 711 are received within a series of circumferentially-spaced holes (not shown) provided on the roller 700 in areas adjacent the edge. One or more mounting bosses may be provided to each wear component 711 in order to help secure the wear component 711 to the roller 700.

Wear components 711 generally comprise a male interlocking feature 712, and a female interlocking feature 714. The interlocking features 712, 714 are generally aligned and may comprise a polyhedral shape. While not shown, interlocking features 712, 714 may comprise undercuts or dovetail joint portions therebetween.

As autogenous material and/or feed follows flow paths 790 in a direction along roller axis 703, it is held back by wear components 711. Wear components 711 may be recessed, flush, or sit proud with respect to the outer surface 705, in order to form a material dam. Since male and female interlocking features 712, 714 are interconnected or interfitted with adjacent male and female interlocking features 712, 714 of circumferentially-adjacent wear components 711, a greater resistance to axial pull-off is provided, as each wear component 711 is additionally supported by surrounding wear components 711.

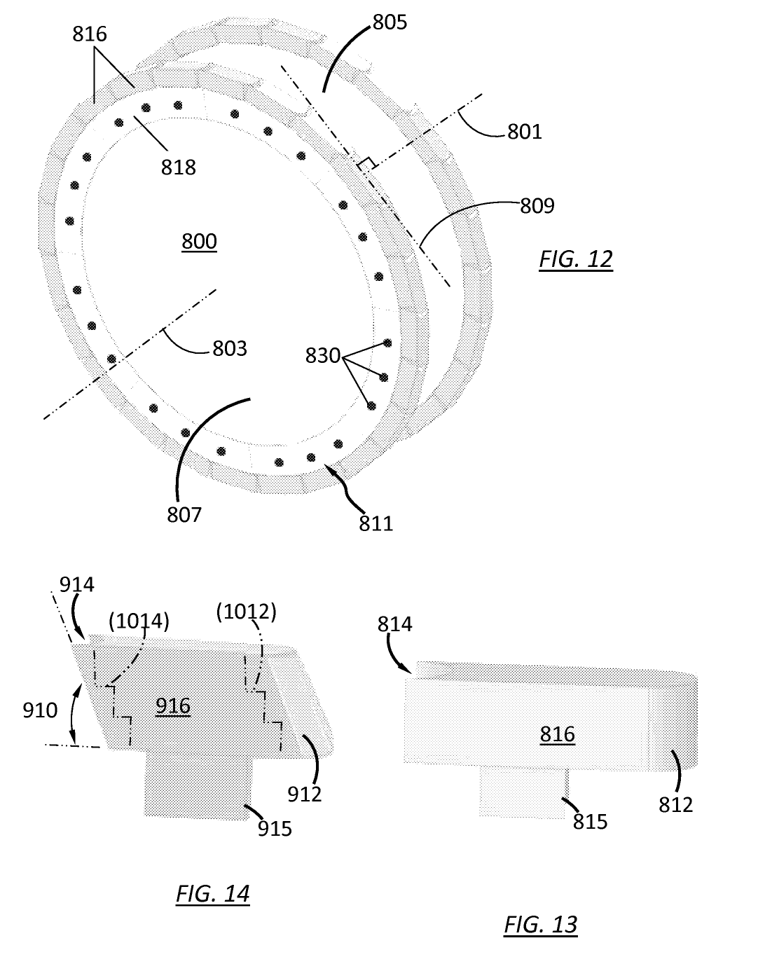

FIG. 12 is an isometric view of a roller 800 according to some embodiments. The roller 800 comprises a roller axis 803, an outer surface 805, and a plurality of wear components 811 held to an abutment surface 807 of the roller 800 by a plurality of fasteners 830. Each wear component generally comprises a first base material component 818 supporting one or more first hard material components 816. As shown in FIG. 13, first hard material components 816 provided on the first base material components 818 may comprise a male interlocking feature 812, a female interlocking feature 814, and one or more mounting bosses 815, which may be keel or fin-shaped, or otherwise elongated, oblong, symmetrical, or non-symmetrical without limitation.

FIG. 14 is a side view of a first hard material component 916 incorporating a radially-oblique angle 910 on both male 912 and female 914 interlocking features. The angle 910 provides support not only in a direction along the axis 803 of a roller 800 and in a tangential direction 809, but also provides support to each first hard material component 816 in a radial direction 801, as well. Angle 910 may be provided in many different ways, including, but not limited to providing stepped male 1012 and female 1014 interlocking features as indicated by dotted lines in FIG. 14. First hard material component 916 may comprise one or more mounting bosses 915, which may be fin-shaped, or otherwise elongated, oblong, symmetrical, non-symmetrical, or provides in the form of a keel without limitation.

While not shown, gaps between interlocking features may be filled with filled with weld material in order to permanently join the wear components to the roller and to each other. Moreover, while not shown, mating surfaces between the interlocking features of wear components may comprise one or more interlocking features such as a mating lip, a tongue-in-groove structure, a dovetail structure, a peg-in-hole connection, mating serpentine surfaces, mating undulated surfaces, mating stepped portions, or interfitting castellation features, in order to increase surface contact.

A contractor or other entity may provide a roller press, roller press sleeve, wear component, or wear component assembly, or operate a roller press in whole, or in part, as shown and described. For instance, the contractor may receive a bid request for a project related to designing or operating a roller press or edge wear component assembly, or the contractor may offer to design such a system or a process for a client. The contractor may then provide, for example, any one or more of the devices or features thereof shown and/or described in the embodiments discussed above. The contractor may provide such devices by selling those devices or by offering to sell those devices. The contractor may provide various embodiments that are sized, shaped, and/or otherwise configured to meet the design criteria of a particular client or customer. The contractor may subcontract the fabrication, delivery, sale, or installation of a component of the devices disclosed, or of other devices used to provide said devices. The contractor may also survey a site and design or designate one or more storage areas for stacking the material used to manufacture the devices, or for storing the devices and/or components thereof. The contractor may also maintain, modify, or upgrade the provided devices. The contractor may provide such maintenance or modifications by subcontracting such services or by directly providing those services or components needed for said maintenance or modifications, and in some cases, the contractor may modify an existing roller press, roller sleeve, wear component assembly, or parts thereof with a “retrofit kit” to arrive at a modified roll press system comprising one or more method steps, devices, or features of the systems and processes discussed herein.

Although the invention has been described in terms of particular embodiments and applications, one of ordinary skill in the art, in light of this teaching, can generate additional embodiments and modifications without departing from the spirit of or exceeding the scope.

For example, it is envisaged that interlocking features may comprise different shapes and sizes depending on the overall design specifications of a roller. Moreover, while receiving portions are primarily shown in the drawings as blind or through holes, receiving portions may comprise any one or more of the following without limitation: openings (threaded or non-threaded), apertures, recesses, pockets, grooves, channels, dovetails, cutout portion, or undercuts. Additionally, attachment features may comprise threaded holes, connectors, undercuts for receiving plastically-deformed material (e.g., via explosion or mechanical deformation processes like swaging), weld chamfers or channels for accommodating weld pools, glue holes, anchors, inserts, etc. Furthermore, mounting bosses may be of the same material or different material as the first hard material components.

It is contemplated that male and female interlocking features disclosed herein may be reversed and still be within the scope of the disclosure. For example, male interlocking features and female interlocking features may be reversed. Moreover, joining of fasteners and attachment features may be accomplished using a threaded connection, plastic deformation, welding, gluing, combinations thereof, or other equivalent means without limitation. Mounting bosses, receiving portions, fasteners, and attachment features may be provided in any number or configuration which is suitable for the intended purpose of the roller.

Accordingly, it is to be understood that the drawings and descriptions herein are proffered by way of example to facilitate comprehension of the invention and should not be construed to limit the scope thereof.

### REFERENCE NUMERAL IDENTIFIERS

1, 100, 200, 500, 600, 700, 800 Roller

3, 103, 203, 603, 703, 803 Roller axis

5, 105, 205, 505, 605, 705, 805 Outer surface

7, 107, 207, 507, 607, 707, 807 Abutment surface

11, 111, 211, 311, 411, 511, 611, 711, 811 Wear component

112, 212, 312, 612, 712, 812, 912 Male interlocking feature

114, 214, 314, 614, 714, 814, 914 Female interlocking feature

115, 315, 415, 520, 815, 915 Mounting boss

116, 216, 316, 416, 516, 816, 916 First hard material component

117, 317 Axis (follows roller edge perimeter)

118, 218, 318, 418, 518, 818 First base material component

80, 180, 280, 580, 680, 780 Wear insert

90, 190, 690, 790 Flow path (of autogenous layer material)

202, 502 Attachment feature

213, 513 Channel

215, 515 Receiving portion

217, 517 Second hard material component

219, 519 Weld or solder bead

230, 530, 830 Fastener

232, 532 Attachment feature

510 Second base material

801 Radial direction

809 Tangential direction

910 Radially-oblique angle

1012 Stepped or castellated male interlocking feature

1014 Stepped or castellated female interlocking feature

What is claimed is:

1. A roller press comprising:
a roller [100, 200] having an axis [103, 203];
an outer surface [105, 205] containing one or more wear inserts [180, 280];
an annular abutment surface [107, 207] proximate an end of the outer surface [105, 205] and extending generally transversely with respect to the outer surface [105, 205] of the roller [100, 200]; and,
a plurality of wear components [111, 211] extending from the abutment surface [107, 207] in a direction generally parallel to the axis [103, 203] of the roller [100, 200], wherein at least two of the wear components [111, 211] are circumferentially interlocked with one another so as to:
a) resist pull-off forces of the at least two wear components [111, 211]; or,
b) reduce material flow between said at least two wear components [111, 211]; or,
c) reduce material flow between other wear inserts [180, 280] located on the roller [100, 200].

2. The roller press according to claim 1, wherein the plurality of wear components [111, 211] extend radially away from the axis [103, 203] of the roller [100, 200] and past the outer surface [105, 205] of the roller [100, 200].

3. The roller press according to claim 1, wherein a tortured path is formed between said circumferentially interlocked wear components [111, 211].

4. The roller press according to claim 1, wherein the circumferentially interlocked wear components [111, 211] fit together or otherwise complement each other in three-dimensional space like jigsaw puzzle pieces.

5. The roller press according to claim 1, wherein each of the circumferentially interlocked wear components [111, 211], when collectively assembled to the roller [100, 200], help resist pullout or washout forces acting to remove other wear components [111, 211] in at least one of the directions selected from the group consisting of a radial direction [801], a tangential direction [809], and a direction parallel to the roller axis [803].

6. The roller press according to claim 1, wherein one or more fasteners [230] are received by complimentary receiving portions [215] in the wear components [211], and wherein the one or more fasteners [230] secure the wear components [211] to the abutment surface [207] of the roller [200] via one or more attachment features [202].

7. The roller press according to claim 1, wherein said wear components [111, 211, 311, 411] each comprise a first base material component [118, 218, 318, 418] and a first hard material component [116, 216, 316, 416].

8. The roller press according to claim 7, wherein said wear components [211, 511] each further comprise a second hard material component [217, 517] provided to the first base material component [118, 218, 318, 418].

9. The roller press according to claim 8, wherein said second hard material component [217, 517] comprises one or more channels [213, 513] configured to receive a weld or a solder bead [219, 519], wherein said weld or solder bead [219, 519] permanently attaches the second hard material component [217, 517] to the first base material component [218, 518].

10. The roller press according to claim 9, wherein said one or more channels [213, 513] comprise a taper so as to create a weld or solder bead [219, 519] having an overhang or dovetail which captures the second hard material component [217, 517] to the first base material component [218, 518].

11. The roller press according to claim 1, wherein the wear components [211] circumferentially interlock when one or more female interlocking features [114, 214, 314, 614, 714, 814, 914] of one wear component [211] substantially engage one or more complimentary male interlocking features [112, 212, 312, 612, 712, 812, 912] of another wear component [211].

12. The roller press according to claim 11, wherein the or more female interlocking features [114, 214, 314, 614, 714, 814, 914] and the one or more male interlocking features [112, 212, 312, 612, 712, 812, 912] comprise a complimentary curve, a complimentary angle [910], a complimentary castellation [1012, 1014], or other complimentary profile in at least one of the following directions: a radial direction [801], a tangential direction [809], and a direction parallel to the roller axis [803].

13. A roller [100, 200] for use in comminution comprising:
an axis [103, 203];
an outer surface [105, 205] containing one or more wear inserts [180, 280];
an annular abutment surface [107, 207] proximate an end of the outer surface [105, 205] and extending generally transversely with respect to the outer surface [105, 205] of the roller [100, 200]; and,
a plurality of wear components [111, 211] extending from the abutment surface [107, 207] in a direction generally parallel to the axis [103, 203] of the roller [100, 200], wherein at least two of the wear components [111, 211] are circumferentially interlocked with one another so as to:
a) resist pull-off forces of the at least two wear components [111, 211]; or,
b) reduce material flow between said at least two wear components [111, 211]; or,
c) reduce material flow between other wear inserts [180, 280] located on the roller [100, 200].

14. The roller press according to claim 13, wherein the plurality of wear components [111, 211] extend radially away from the axis [103, 203] of the roller [100, 200] and past the outer surface [105, 205] of the roller [100, 200].

15. The roller press according to claim 13, wherein a tortured path is formed between said circumferentially interlocked wear components [111, 211].

16. The roller press according to claim 13, wherein the circumferentially interlocked wear components [111, 211] fit together or otherwise complement each other in three-dimensional space like jigsaw puzzle pieces.

17. The roller press according to claim 13, wherein each of the circumferentially interlocked wear components [111, 211], when collectively assembled to the roller [100, 200], help resist pullout or washout forces acting to remove other wear components [111, 211] in at least one of the directions selected from the group consisting of: a radial direction [801], a tangential direction [809], and a direction parallel to the roller axis [803].

18. The roller press according to claim 13, wherein one or more fasteners [230] are received by complimentary receiving portions [215] in the wear components [211], and wherein the one or more fasteners [230] secure the wear components [211] to the abutment surface [207] of the roller [200] via one or more attachment features [202].

19. The roller press according to claim 13, wherein said wear components [111, 211, 311, 411] each comprise a first base material component [118, 218, 318, 418] and a first hard material component [116, 216, 316, 416].

20. The roller press according to claim 19, wherein said wear components [211, 511] each further comprise a second hard material component [217, 517] provided to the first base material component [118, 218, 318, 418].

21. The roller press according to claim 20, wherein said second hard material component [217, 517] comprises one or more channels [213, 513] configured to receive a weld or a solder bead [219, 519], wherein said weld or solder bead [219, 519] permanently attaches the second hard material component [217, 517] to the first base material component [218, 518].

22. The roller press according to claim 21, wherein said one or more channels [213, 513] comprise a taper so as to create a weld or solder bead [219, 519] having an overhang or dovetail which captures the second hard material component [217, 517] to the first base material component [218, 518].

23. The roller press according to claim 13, wherein the wear components [211] circumferentially interlock when one or more female interlocking features [114, 214, 314, 614, 714, 814, 914] of one wear component [211] substantially engage one or more complimentary male interlocking features [112, 212, 312, 612, 712, 812, 912] of another wear component [211].

24. The roller press according to claim 23, wherein the or more female interlocking features [114, 214, 314, 614, 714, 814, 914] and the one or more male interlocking features [112, 212, 312, 612, 712, 812, 912] comprise a complimentary curve, a complimentary angle [910], a complimentary castellation [1012, 1014], or other complimentary profile in at least one of the following directions: a radial direction [801], a tangential direction [809], and a direction parallel to the roller axis [803].

25. A first wear component [111, 211] which is configured to circumferentially interlock with a second wear component [111, 211] having a similar size and configuration as the first wear component, the first wear component further being configured to secure to an annular abutment surface [107, 207] of a roller [100, 200], the annular abutment surface [107, 207] being proximate an end of an outer surface [105, 205] of the roller [100, 200] and extending generally transversely with respect to the outer surface [105, 205];
wherein in use, when said first wear component [111, 211] is circumferentially interlocked with said second wear component [111, 211], a geometry of the first wear component [111, 211] serves to perform one of the following:
a) resist pull-off forces acting on the second wear component [111, 211]; or,
b) reduce material flow between said first and second wear components [111, 211]; or,
c) reduce material flow between other wear inserts [180, 280] located on the roller [100, 200].

26. The first wear component [111, 211] according to claim 25, wherein in use, a tortured path is formed when said first wear component [111, 211] is circumferentially interlocked with the second wear component [111, 211].

27. The first wear component [111, 211] according to claim 25, wherein in use, the first wear component [111, 211] fits together with or otherwise complements the second wear component [111, 211] in three-dimensional space like a jigsaw puzzle piece.

28. The first wear component [111, 211] according to claim 25, wherein in use, the first wear component [111, 211] helps to resist pullout or washout forces acting to remove the second wear component [111, 211] in at least one of the directions selected from the group consisting of a radial direction [801], a tangential direction [809], and a direction parallel to the roller axis [803].
